(19) United States
(12) Patent Application Publication
(10) Pub. No.: US 2003/0120803 A1
(43) Pub. Date: Jun. 26, 2003

(54) System and method for mobile network access

(76) Inventors: Stephen A. Loughran, Corvallis, OR (US); Rajeev K. Pandey, Corvallis, OR (US); Charles M. Patton, Eugene, OR (US)

Correspondence Address: HEWLETT-PACKARD COMPANY, Intellectual Property Administration, P.O. Box 272400, Fort Collins, CO, 80527-2400, US

(21) Appl. No.: 10/029,161

(22) Filed: Dec. 21, 2001

(51) Int. Cl. G06F 15/173

(52) U.S. Cl. 709/238; 709/227

(57) ABSTRACT

A system, method, and a program embodied in a computer readable medium are provided for network tunneling. In one embodiment, a network tunneling method is described that comprises the steps of providing a client linked to a network, simulating an operation of a modem in the client with respect to a portable device, and tunneling a network access by the portable device from the client to a network portal.

### TECHNICAL FIELD

The present invention is generally related to the field of data communications and, more particularly, is related to a system and method for mobile network access.

### BACKGROUND

More and more people are becoming hooked to personal digital assistants. These handy devices are pocket-sized minicomputers that execute a growing number of applications for users. For example, almost all personal digital assistants provide address books, scheduling applications, electronic mail, and other applications.

Due to the limited computing capacity of many personal digital assistants and the limited user interfaces they employ, many applications are distributed between the personal digital assistant and a separate computing device such as a personal computer, etc. For example, an address book may be maintained in parallel on a personal digital assistant and on a personal computer. In such situations, entries into the address book are often made using either the personal digital assistant or the personal computer. However, due to the fact that the personal computer has a full keyboard and a larger screen, a user often will prefer to enter such information using the personal computer. To maintain the same address book in both the PDA and the personal computer, data synchronization systems are often employed.

Since personal digital assistants are mobile devices, they can be very convenient in that they can organize an individual's affairs and always be available. However, for situations where an application is operated in parallel, synchronization only takes place when the user can attach the personal digital assistant to the personal computer so that they can communicate with each other. This presents a problem when a user travels extensively and is unable to connect their personal digital assistant to allow synchronization to occur.

To address such a scenario, the parallel application may be maintained on a server coupled to a network such as the Internet. Alternatively, the personal computer might be coupled to the same network. In this situation, the modem may be used to dial up to the network to establish data communication with the personal computer or with the server that maintains the parallel operation of the desired application. In this manner, synchronization of the application data can occur remotely. Unfortunately, this means that the user must carry the modem in addition to the personal digital assistant. In addition, in order to access a network such as the Internet, a user must potentially make costly telephone calls even though network based Internet access is available.

### SUMMARY

In light of the foregoing, the present invention provides for a system, method, and a program embodied in a computer readable medium for network tunneling. In one embodiment, a network tunneling method is described that comprises the steps of providing a client linked to a network, simulating an operation of a modem in the client with respect to a portable device, and tunneling a network access by the portable device from the client to a network portal.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a data communications network that includes a client with a network tunneling system and a network portal server with a network portal system; and

FIG. 2 is a flow chart of the network tunneling system of FIG. 1.

### DETAILED DESCRIPTION

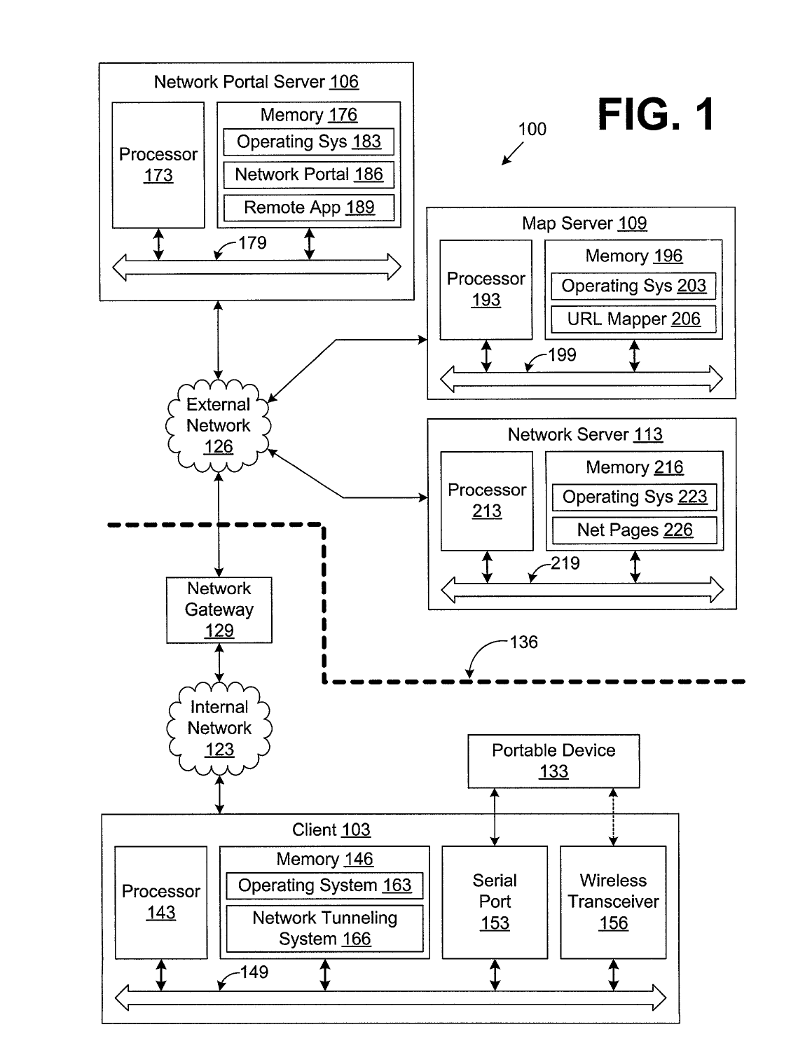

With respect to FIG. 1, shown is a data communications network according to an aspect of the present invention. The data communications network 100 includes a client 103, a network portal server 106, a map server 109, and a network server 113. The data communications network 100 also includes an internal network 123 and an external network 126. The internal network 123 and the external network 126 are coupled through a network gateway 129 as shown. In this respect, the internal network 123 may comprise, for example, Local Area Networks (LAN), Intranets, or other networks as can be appreciated by those with ordinary skill in the art. The external network 126 may comprise, for example, the Internet, Wide Area Networks (WAN), Local Area Networks, Intranets, or other networks. The internal network 123 and the external network 126 may also comprise any combination of the above mentioned networks.

While only the client 103 is shown as being coupled to the internal network 123, it is understood that many other devices may be coupled to the internal network 123 as is commonly seen in various organizations such as companies in an office environment. Likewise, there may be many other clients and/or servers beyond the network portal server 106, map server 109, and network server 113 that are coupled to the external network 126.

The data communications network 100 also includes a portable device 133 that communicates with the client 103 as will be discussed. In this respect, the portable device 133 may be, for example, a personal digital assistant, a laptop computer, a notebook computer, a digital camera, or any other like system that communicates with a modem as will be described.

The data communications network 100 also includes a firewall 136 that limits access to devices on the internal network 123 by devices coupled to the external network 126. In this respect, the client 103 is located on a protected side of the firewall 136 relative to the external network 126 and the devices coupled thereto.

The client 103 includes a processor circuit having a processor 143 and a memory 146, both of which are coupled to a local interface 149. In this respect, the local interface may be, for example, a data bus with an accompanying control/address bus as can be appreciated by those with ordinary skill in the art. Thus, the client 103 may be, for example, a computer system or other system with like capability. The client 103 also includes one of what may be a number of different alternative interfaces that facilitate communication between the client 103 and the portable device 133. In this respect, the client 103 may include a serial port 153 and/or a wireless transceiver 156. In addition, other interface devices may be included in the client 103 to facilitate communication with a respective portable device 133. The serial port 153, for example, provides an input plug by which the portable device 133 may be directly coupled using a serial cable with some modifications as will be discussed. The wireless transceiver 156 facilitates wireless communication with the portable device 133 by one of any number of protocols including, for example, infrared (IR), the Bluetooth, or other wireless protocol as can be appreciated by those with ordinary skill in the art.

The client 103 also includes software components that are stored on the memory 146 and are executable by the processor 143. These software components may comprise, for example, an operating system 163, and a network tunneling system 166 that is executed to tunnel network access to devices on the external network 126 by the portable device 133 through the firewall 136 to the network portal server 106 as will be discussed.

The network portal server 106 also includes a processor circuit with a processor 173 and a memory 176, both of which are coupled to a local interface 179. In this respect, the local interface 179 may be, for example, a data bus with an accompanying control/address bus, etc. Thus, the network portal server 106 may be, for example, a computer system or other system with like capability. The network portal server 106 also includes a number of software components that are stored on the memory 176 and are executable by the processor 173. In this respect, the network portal server 106 includes an operating system 183, a network portal 186, and one or more remote applications 189. The network portal 186 is executed by the processor 173 to provide network access on the external network 126 for the portable device 133. Specifically, the network tunneling system 166 tunnels network access of the portable device 133 to the network portal 186 as will be discussed. The remote application 189 may be, for example, one or more different applications that are accessed using the portable device 133 as will be described.

The map server 109 also includes a processor circuit with a processor 193 and a memory 196, both of which are coupled to a local interface 199. In this respect, the local interface 199 includes a data bus with an accompanying control/address bus, etc. Thus, the map server 109 may be, for example, a computer system or other system with like capability. The map server 109 includes software components that are stored on the memory 196 and are executable by the processor 193. In this respect, the map server 109 includes an operating system 203 and a uniform resource locator (URL) mapper 206. The URL mapper 206 is employed to obtain a network address of the network portal 186 used in tunneling the network access of the portable device 133 through the firewall 136 to the network portal 186 as will be described.

The network server 113 also includes a processor circuit having a processor 213 and a memory 216, both of which are coupled to a local interface 219. In this respect, the network server 113 may be, for example, a computer system or other system with like capability. The network server 113 includes a number of software components that are stored on the memory 216 and are executable by the processor 213. Specifically, the network server 113 includes an operating system 223 and one or more network pages 226. The network pages 226 are served up to clients 103 that are coupled to the external network 126 in response to requests therefore as can be appreciated by those with ordinary skill in the art. In this respect, the network server 113 may operate as a web server, for example, that serves up web pages according to the Hypertext Transfer Protocol (HTTP) that is used on the World Wide Web as can be appreciated by those with ordinary skill in the art. The network server 113 may serve up the network pages 226 using another protocol beyond that employed on the World Wide Web.

Next a general description of the operation of the data communications network 100 in providing network access on the external network 126 to the portable device 133 is described. To begin, assume that a user of the portable device 133 wishes to access content on one or more servers 113 that are coupled to the external network 126. At the same time the user is physically located in an area in which local equipment is coupled to the internal network 123 behind the firewall 136. As such, the owner of the internal network 123 and devices coupled thereto may not wish for the user to have access to the devices on the internal network 123. Consequently, the user is prevented from linking with the internal network 123 with the portable device 133 to obtain ultimate access to devices coupled to the external network 126 through the network gateway 129.

According to an aspect of the present invention, the user is provided access to devices on the external network 126 by establishing a data communications link with the client 103 and by tunneling access of the potable device 133 outside of the internal network 123 beyond the firewall 136 to the network portal 186. The tunneled access by the portable device 133 to the network portal 186 ultimately provides access to all other devices on the external network 126 without providing access to devices on the internal network 123. To facilitate the tunneled access, the portable device 133 includes a modem that is normally employed to link with a telecommunications network. The telecommunications network is ultimately coupled to the external network 126 such as is the case, for example, with the average Internet Service Provider or other similar entity.

The client 103 includes the network tunneling system 166 that simulates the operation of a modem with respect to the portable device 133. Specifically, the network tunneling system 166 acts like a modem that communicates with the modem in the portable device 133 to establish a data communications link between the client 103 and the portable device 133. In this respect, the data communications link between the portable device 133 and the client 103 may be through a hardwire connection such as serial cable, a Universal Serial Bus (USB) connection, or other hardware connection. Alternatively, a wireless connection may be established between the portable device 133 and the client 103 through the wireless transceiver 156.

In simulating a modem operation a network tunneling system 166 causes the appropriate hand shaking signals and other signals that would normally be recognized by a calling modem from the portable device 133. As is set forth in applicable telecommunications standards. Note that in the case that the data communications link is established with a serial communications cable connected between the portable device 133 and serial port 153, it may be necessary to reorder the pins in the serial cable to allow for proper signaling.

Once the data communications link is established between the portable device 133 and the network tunneling system 166 in the client 103, then the network tunneling system 166 establishes a communications channel with the network portal 186 in the network portal server 106. To establish the channel between the network tunneling system 166 and the network portal 186, the network tunneling system first must obtain a network address of the network portal 186 on the external network 126. In establishing a data communications link between the portable device 133 and the network tunneling system 166, a telephone number is received from the portable device 133 during the simulated call setup. Upon obtaining the telephone number, the network tunneling system 166 queries the uniform resource locator (URL) mapper 206 for the network address of the network portal 186 that is associated with the portable device 133 based upon telephone number.

In this respect, multiple different network portals 186 may exist on the external network 126, each network portal 186 serving a predetermined number of portable devices 133. In querying the URL mapper 206, the network tunneling system 166 generates a request that is sent to the URL mapper 206 that includes the telephone number received from the portable device 133 during the initiation of the simulated telephone call therewith. The URL mapper 206 maps the telephone number to a predefined network address associated with the respective network portal 186 to which network access by the portable device 133 is to be tunneled. Thus, each telephone number called by a respective portable device 133 is associated with a respective network portal 186.

Upon identifying the network address of the network portal 186, the URL mapper transmits a response to the query of the network tunneling system 166 that includes the respective network address of the network portal 186 that is associated with the telephone number. Upon receipt of the network address of the network portal 186, the network tunneling system 166 then proceeds to open a channel with the network portal 186. The channel between the network tunneling system 166 and the network portal 186 may be established in one of the number of ways, depending on the nature of the external network 126, the protocol employed by the external network 126, and the protocol employed between the network tunneling system 166 and the network portal 186 as can be appreciated by those with ordinary skill in the art.

Once the channel is established between the network tunneling system 166 and the network portal 186, the network tunneling system 166 then serves to relay all communication from the portable device 136 to the network portal 186 through the internal network 123 and the firewall 136. At the same time, the user of the portable device 133 is not provided any access to devices coupled to the internal network 123, except for all access to internal devices provided to devices on the external network 126 through the network gateway 129. This is due to the relay function of the network tunneling system 166.

The network portal 186 then proceeds to obtain all information from devices on the external network 126 as requested by the portable device 133. Any information such as network pages 226 or other content that the network portal 186 obtains based upon a request by the portable device 133 is then tunneled back to the portable device 133 by the network portal 186. In this respect, the network portal 186 tunnels all responses to any request by the portable device 133 back to through the external network 126, the network gateway 129 and the internal network 123 to the client 103. Ultimately the portable device 133 appears to have direct access to devices on the external network 126 through the network portal 186 even though a physical data communications link is established between the portable device 133 with the client 103 on a protected side of the firewall 136.

In addition, the tunneling effect of the network tunneling system 166 prevents access by the user of the portable device 133 to files or other data stored on devices coupled to the internal network 123. In this respect, the portable device 133 may access a remote application 189 such as, for example, an address book, telephone number list, a calendar program, or other like application through the network portal 186. Although the remote application 189 is shown as residing on the network portal server 106, it is understood that the remote application 189 may reside on any server coupled to the external network 126. Alternatively, the portable device 133 may access any network pages 226 that are served up by a respective network server 113 on the external network 126, etc.

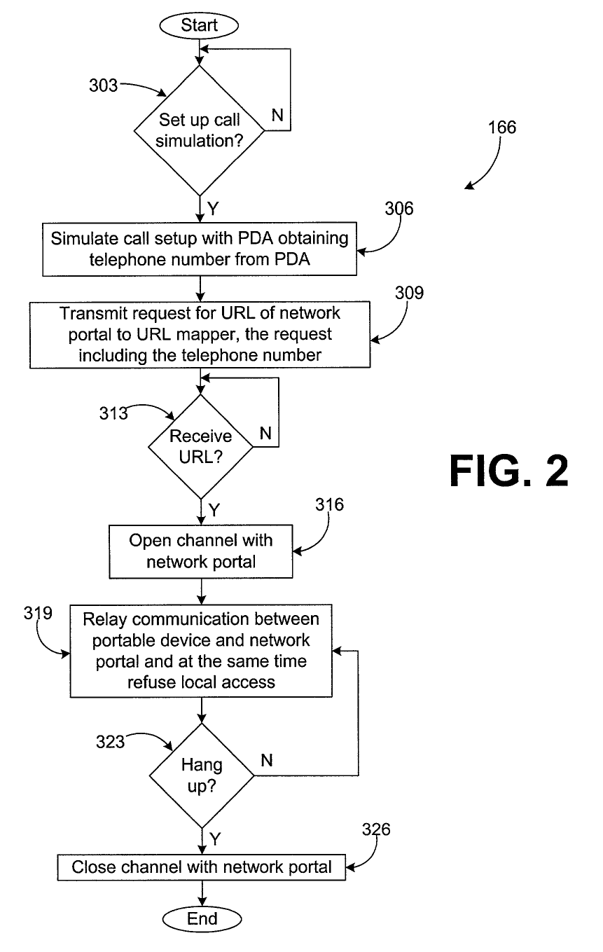

Turning then to FIG. 2, shown is a flow chart of the network tunneling system 166 according to an aspect of the present invention. Alternatively, the flow chart of FIG. 2 may be viewed as depicting steps of a method implemented in the client 103. The network tunneling system 166 and the network portal 186 may be created in any one of a number of computer languages such as, for example, C++, Java, and other appropriate languages.

To begin, in box 303 the network tunneling system 166 waits to perform the simulation of a modem in establishing a data communications link with the portable device 133 (FIG. 1) by simulating a called modem in the client 103. Assuming that the portable device 133 has initiated such a call, then in box 306 the network tunneling system 166 simulates the setup procedure with the portable device 133 and obtains the telephone number from the portable device 133 during the course of the initiation of the telephone call. Thereafter, in box 309, the network tunneling system 166 queries the URL mapper 206 (FIG. 1) for an associated network address of the network portal 186 based upon the telephone number. This is done, for example, by transmitting a request to the URL mapper 206 for the associated network address where the request includes the telephone number itself.

Thereafter, in box 313, the network tunneling system 166 determines whether an appropriate network address of the network portal 186 has been received from the URL mapper 206. Assuming such is the case, then the network tunneling system 166 proceeds to box 316 in which a channel is opened with the network portal 186. Thereafter, in box 319, the network tunneling system 166 relays communication between the portable device 133 and the network portal 186. During the relaying of such data communication, the network tunneling system 166 denies local access to devices on the internal network 123 to the portable device 133. Thereafter, in box 323, the network tunneling system 166 determines whether a hang-up has occurred. Such would be the case, for example, when the portable device 133 hangs up after the user stops the operation thereof assuming that they have achieved their goals accessing the external network 126 (FIG. 1). If in box 323 there is no hang-up condition, then the network tunneling system 166 remains in box 319 and continues to relay communication as is appropriate. However, assuming that a hang-up condition 323 occurs, then the network tunneling system 166 proceeds to box 323 in which the channel between the network tunneling system 166 and the network portal 186 is closed. Thereafter, the network tunneling system 166 ends accordingly.

Although the network tunneling system 166 (FIG. 2) of the present invention is embodied in software or code executed by general purpose hardware as discussed above, as an alternative the network tunneling system 166 may also be embodied in dedicated hardware or a combination of software/general purpose hardware and dedicated hardware. If embodied in dedicated hardware, the network tunneling system 166 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow chart of FIG. 2 shows the architecture, functionality, and operation of an implementation of the network tunneling system 166. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow chart of FIG. 2 shows a specific order of execution, it is understood that the order of execution may differ from that which is depicted. For example, the order of execution of two or more blocks may be scrambled relative to the order shown. Also, two or more blocks shown in succession in FIG. 2 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention. Also, the flow chart of FIG. 2 is relatively self-explanatory and is understood by those with ordinary skill in the art to the extent that software and/or hardware can be created by one with ordinary skill in the art to carry out the various logical functions as described herein.

Also, where the network tunneling system 166 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the network tunneling system 166 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to the embodiments described above, it is obvious that equivalents and modifications will occur to others skilled in the art upon the reading and understanding of the specification. The present invention includes all such equivalents and modifications, and is limited only by the scope of the claims.

What is claimed is:

1. A network tunneling method, comprising:
providing a client linked to a network;
simulating an operation of a modem in the client with respect to a portable device; and
tunneling a network access by the portable device from the client to a network portal.

2. The network tunneling method of claim 1, wherein the step of tunneling the network access by the portable device from the client to the network portal further comprises tunneling the network access beyond a protected side of a firewall where the client is located on the protected side of the firewall.

3. The network tunneling method of claim 1, wherein the step of tunneling the network access by the portable device from the client to the network portal further comprises obtaining a network address of the network portal.

4. The network tunneling method of claim 3, wherein the step of obtaining the network portal address of the network portal associated with the portable device further comprises:
obtaining a telephone number from the portable device that is employed to access the network portal through a telecommunications network; and
querying a uniform resource locator (URL) mapper for the network portal address that is associated with the telephone number.

5. The network tunneling method of claim 1, further comprising establishing a channel between the client and the network portal.

6. The network tunneling method of claim 5, further comprising accessing a mobile application maintained at the network portal.

7. The network tunneling method of claim 5, further comprising accessing a network page from a server coupled to the network through the network portal.

8. A program embodied in a computer readable medium that provides network access tunneling, comprising:
code that simulates an operation of a modem in a client with respect to a portable device; and
code that tunnels a network access by the portable device from the client to a network portal through a firewall between the client and the network portal.

9. The program embodied in a computer readable medium of claim 8, wherein the code that tunnels the network access by the portable device from the client to the network portal through the firewall between the client and the network portal further comprises code that obtains a network address of the network portal.

10. The program embodied in a computer readable medium of claim 9, wherein the code that obtains the network address of the network portal further comprises:
code that obtains a telephone number from the portable device that is employed to access the network portal through a telecommunications network; and
code that queries a uniform resource locator (URL) mapper for the network portal address that is associated with the telephone number.

11. The program embodied in a computer readable medium of claim 8, wherein the code that tunnels the network access by the portable device from the client to the network portal through the firewall between the client and the network portal further comprises code that establishes a channel between the client and the network portal.

12. A network tunneling system, comprising:
means for simulating an operation of a modem in a client with respect to a portable device; and
means for tunneling a network access by the portable device from the client to a network portal through a firewall between the client and the network portal.

13. The network tunneling method of claim 12, wherein the means for tunneling the network access by the portable device from the client to the network portal through the firewall between the client and the network portal further comprises means for obtaining a network address of the network portal.

14. The network tunneling method of claim 13, wherein the means for obtaining the network address of the network portal further comprises:
means for obtaining a telephone number from the portable device that is employed to access the network portal through a telecommunications network; and
means for querying a uniform resource locator (URL) mapper for the network portal address that is associated with the telephone number.

15. A network tunneling system, comprising:
a client with a processor circuit having a processor and a memory;
a local data communications portal; and
network tunneling logic stored on the memory and executable by the processor, the network tunneling logic comprising:
logic that simulates an operation of a modem in the client with respect to a portable device to establish a data communications link with the portable device through the local data communications portal; and
logic that tunnels a network access by the portable device from the client to a network portal through a firewall between the client and the network portal.

16. The network tunneling system of claim 15, wherein the logic that tunnels the network access by the portable device from the client to the network portal through the firewall between the client and the network portal further comprises logic that obtains a network address of the network portal.

17. The network tunneling system of claim 16, wherein the logic that obtains the network address of the network portal further comprises:
logic that obtains a telephone number from the portable device that is employed to access the network portal through a telecommunications network; and
logic that queries a uniform resource locator (URL) mapper for the network portal address that is associated with the telephone number.

18. The network tunneling system of claim 15, wherein the logic that tunnels the network access by the portable device from the client to the network portal through the firewall between the client and the network portal further comprises logic that establishes a channel between the client and the network portal.
